(19) United States
(12) Patent Application Publication
(10) Pub. No.: US 2008/0075546 A1
(43) Pub. Date: Mar. 27, 2008

(54) Inclined-hole drilling jig

(76) Inventor: Tung-Chuan Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/524,464

(22) Filed: Sep. 21, 2006

(51) Int. Cl. B23B 47/28

(52) U.S. Cl. 408/115 R

(57) ABSTRACT

An inclined-hole drilling jig primarily comprises a frame, at least one guide seat assembled thereon, and a workpiece positioner; wherein, the guide seats each have plural inclined guide channels to accommodate and orient a drill. The present invention is characterized by at least one first inclined guide channel and one second inclined guide channel of the guide seats with diverse inclinations, whereby, the guide seats can provide options for at least two diverse drilling inclinations to cater to users' various needs.

### BACKGROUND OF THE INVENTION

1. Technical Field

The present invention relates to drilling jigs and, more particularly, to an inclined-hole drilling jig having at least two inclined guide channels with diverse inclinations provided on the guide seat thereof.

2. Description of Related Art

There are some typical methods used to fix two wooden sticks perpendicular to each other; for instance, one involves nailing the sticks together, and another involves fastening them by some screw bolts. Before the latter method is to be practiced, plural holes with preset inclined routes must be drilled. However, in a manual drilling operation, deviation of the resulting holes may be frequently incurred as illustrated in FIGS. 10a to 10d when wood veins are encountered, or when hands tremble. Thus, some auxiliary apparatuses have been brought into the art to facilitate smooth and steady drilling operation; for example, an inclined-hole drilling jig.

A conventional inclined-hole drilling jig is typically composed of a guide seat which has thereon an inclined guide channel with a preset inclination that allows a drill passing therethrough to be oriented thereby. Nevertheless, such inclined-hole drilling jig may still be imperfect for practical application.

Since there is only one inclined guide channel provided on the seat of the conventional inclined-hole drilling jig, the jig may fail to fit workpieces with various thicknesses and thus still cause an offset. Although a supplemental guide seat with an alternative inclined guide channel can be implemented to solve this problem, the material and production costs are consequently increased; also, changing the seat during operation consequently causes inefficiency.

Thus, a need exists for a novel inclined-hole drilling jig that is easy to use, efficient and economical.

### SUMMARY OF THE INVENTION

The present invention has been accomplished under the circumstances in view of providing an inclined-hole drilling jig that betters conventional ones having a single inclined guide channel. The disclosed drilling jig comprises a frame with at least one guide seat arranged at a preset position thereon and a workpiece positioner, wherein the guide seat further includes plural inclined guide channels for accommodating and orienting a drill. The technical measures taken by the invention to solve the discussed problem is that each guide seat comprises at least one first inclined guide channel and one second guide channel with diverse inclinations. Thereby, the jig provides at least two options for drilling inclination and satisfies users' diverse demands to accomplish the advancement of practicality.

It is one object of the present invention to provide an inclined-hole drilling jig, which has a concave chip groove provided on the sidewall of said guide seat around the outlet end of the inclined guide channel to facilitate drilling chip removal.

It is another object of the present invention to provide an inclined-hole drilling jig, which contains a rigid liner tube inside the inclined guide channels of the guide seat to enhance the structure and introduce soundness as well as durability for the guide channels.

### BRIEF DESCRIPTION OF THE DRAWINGS

The invention, as well as a preferred mode of use, further objectives and advantages thereof, will best be understood by reference to the following detailed description of an illustrative embodiment when read in conjunction with the accompanying drawings, wherein:

FIG. 1 is a perspective view of one embodiment of the present invention;

FIG. 2 is a partial cross-sectional view of the aforesaid embodiment of the present invention;

FIG. 3 is a schematic view showing a status of use of the aforesaid embodiment;

FIG. 4 is another schematic view showing a status of use of the aforesaid embodiment;

FIG. 5 is yet another schematic view showing a status of use of the aforesaid embodiment;

FIG. 6 is perspective view of another embodiment of the present invention;

FIG. 7 depicts the bottom jig accord to the second embodiment;

FIG. 8 is a partial cross sectional view of the second embodiment;

FIG. 9 is a schematic view showing a status of use of the second embodiment;

FIG. 10a is a schematic view showing drilling operation proceeded with a conventional inclined-hole drilling jig;

FIG. 10b is another schematic view showing drilling operation proceeded with a conventional inclined-hole drilling jig;

FIG. 10c is a further schematic view showing drilling operation proceeded with a conventional inclined-hole drilling jig; and

FIG. 10d is a yet further schematic view showing drilling operation proceeded with a conventional inclined-hole drilling jig.

### DETAILED DESCRIPTION OF THE PREFERRED EMBODIMENT

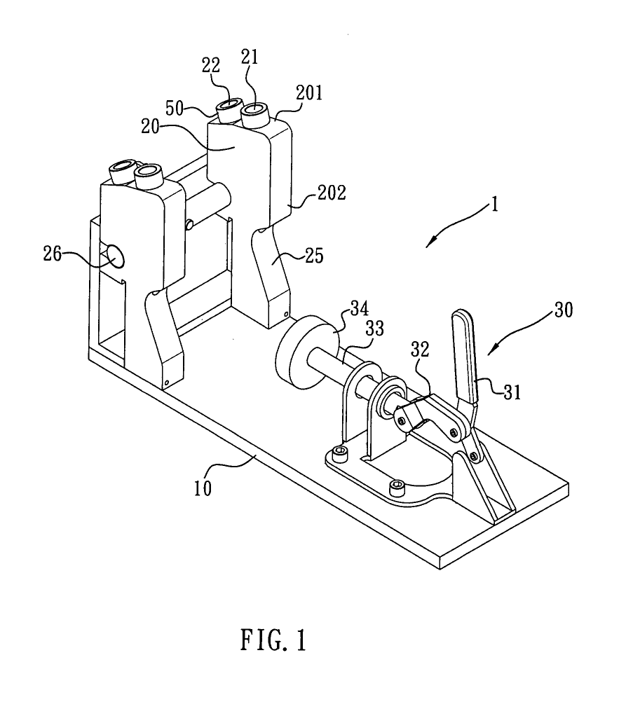

Please refer to FIGS. 1 to 8 for preferred embodiments of the present invention. It is to be noted that the recited embodiments are for the purpose of illustration and are not intended to limit the present invention with the discussed structure.

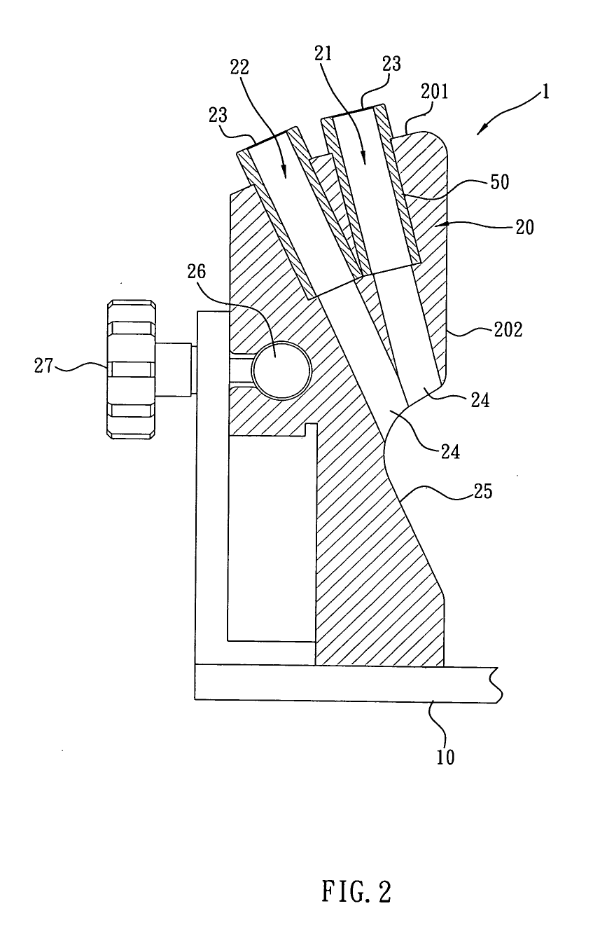

According to one embodiment of the present invention shown in FIG.1 and FIG. 2, the disclosed inclined-hole drilling jig primarily comprises a frame 10, at least one guide seat 20 (in the figures, shown as dual-channel guide seats) assembled thereon, and a workpiece positioner 30; wherein, the guide seats 20 each have plural inclined guide channels 21, 22 to accommodate and orient a drill 40 and the inlet ends 23 of the channels 21, 22 appear at the top surface 201 of the guide seat 20 while the outlet ends 24 thereof appear at one sidewall 202 of the guide seat 20. The present invention is characterized by at least one first inclined guide channel 21 and one second inclined guide channel 22 of the guide seats 20 with diverse inclinations, whereby, the guide seats 20 provide options for at least two diverse drilling inclinations to cater to users' various needs.

Further, a concave chip groove 25 can be provided on the sidewall 202 of the guide seat 20 corresponding to the outlet ends 24 of the inclined guide channels 21, 22.

Also, the inclined guide channels 21, 22 of the guide seat 20 may each contain a liner tube 50 assembled therein to provide a rigid and wear-resisting drill guide channel.

Additionally, the workpiece positioner 30 may be a clamping seat. According to this embodiment, the workpiece positioner 30 is composed of a lever 31, a crank 32, an extension rod 33 and a pressing plate 34.

Moreover, the guide seats 20 assembled on the frame 10 are adjustable to be relatively close or distant. According to the embodiment, the two dual-channel guide seats 20 are parallel and assembled on a transverse guide rod 26 at one end of the frame 10 whereby the dual-channel guide seats 20 can slide along the transverse guide rod 26 to obtain a desired interval and then be fixed with a screwed position knob 27.

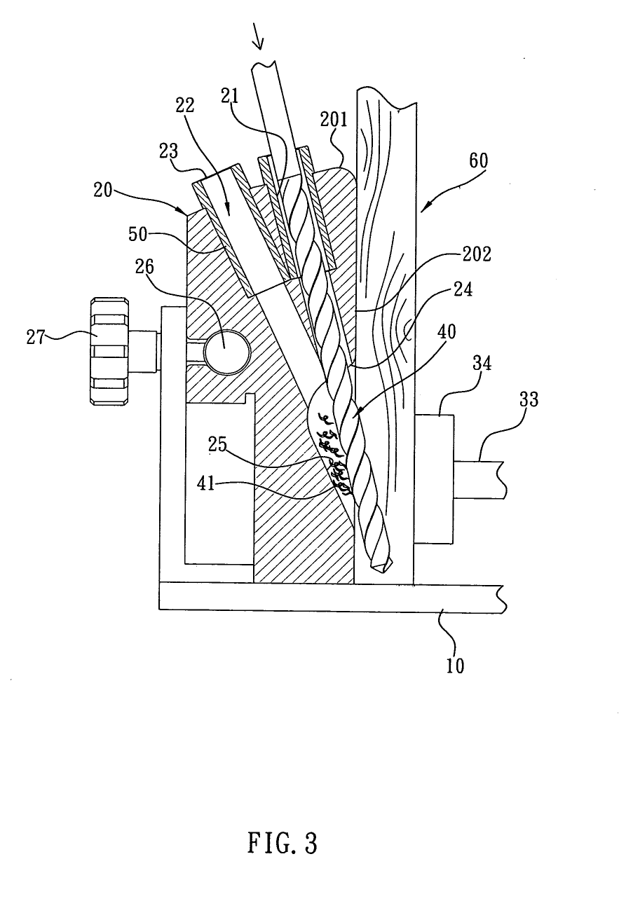

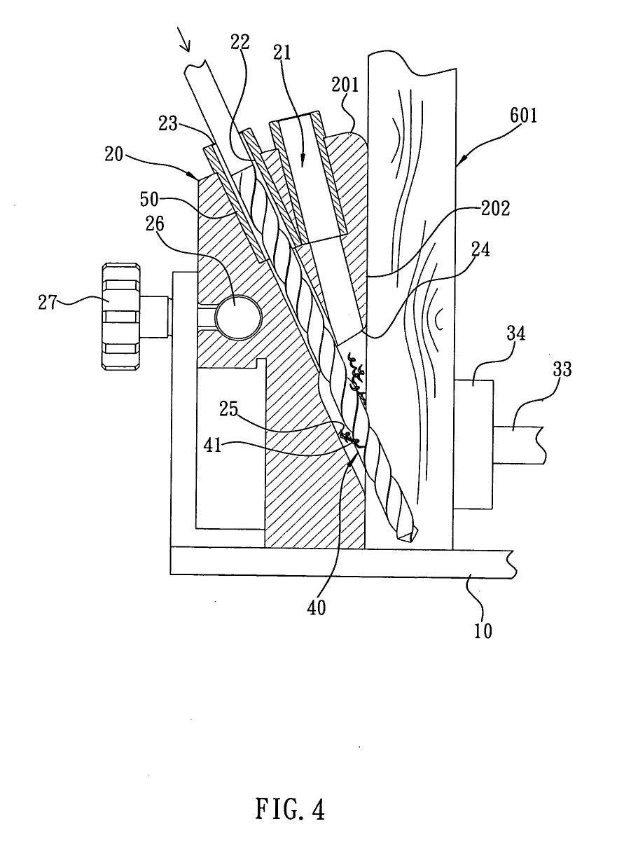

Now referring to FIG. 3, when a drilling jig 1 is implemented for inclined-hole drilling operation, an objective workpiece 60 can be placed at one side of the guide seats 20 and fixed by the pressing plate 34; afterward, a drill 40 passing the inclined guide channel 21 or 22 through the route from the inlet end 23 at the top surface 201 of the guide seats 20 to the outlet end 24 on the sidewall 202 of the guide seats 20 drills through the workpiece 60 by the guided inclination. As drilling chips B are produced during the drilling operation, the chip groove 25 arranged on the sidewall 202 of the guide seats 20 allows the chips 41 to be removed easily. Since the present invention provides at least the first and second guide channels 21, 22 on the guide seats 20, it permits users to drill on workpieces 60, 601 with diverse thickness (comparing FIG. 3 with FIG. 4) and obtain the optimum resultant exit points of the drilling without changing the guide seats. Thus, the disclosed subject matter facilitates convenient and efficient drilling operation.

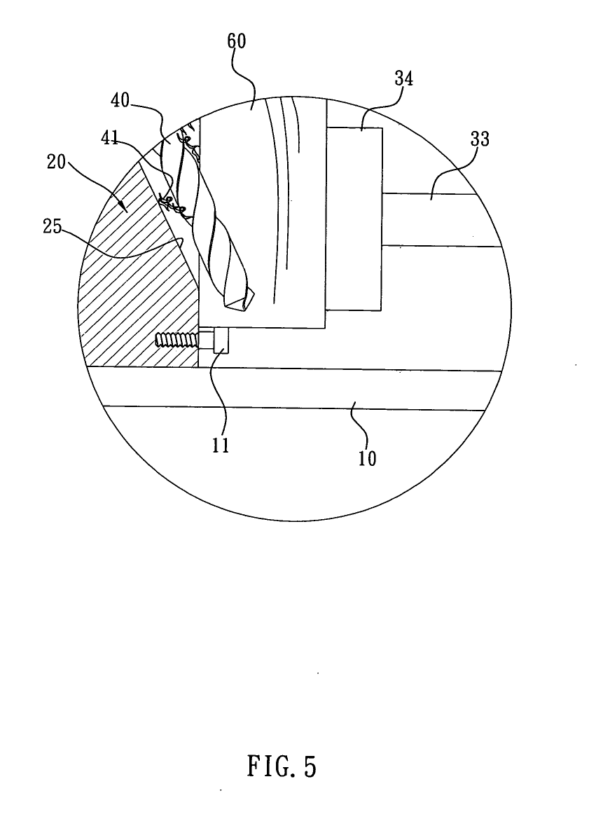

In FIG. 5, when the disclosed matter is used to assist in a drilling operation, it is possible to preset a pedestal 11 on the frame 10 to lift the workpiece 60 for adjustment of the exit point of the drill 40 to a desired position.

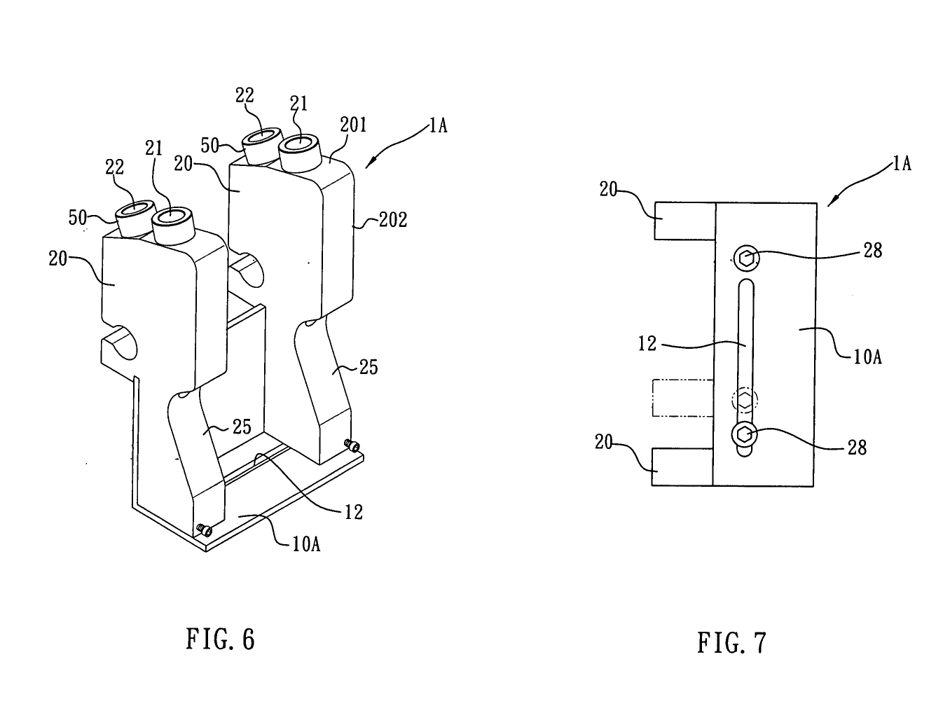

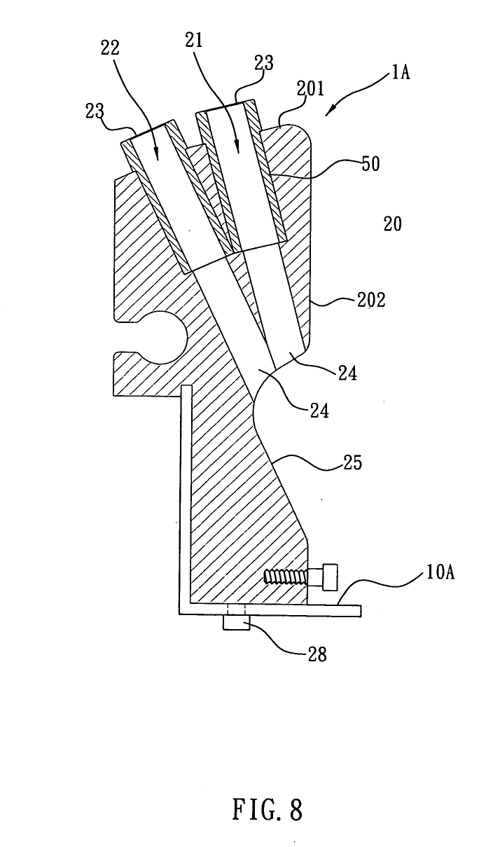

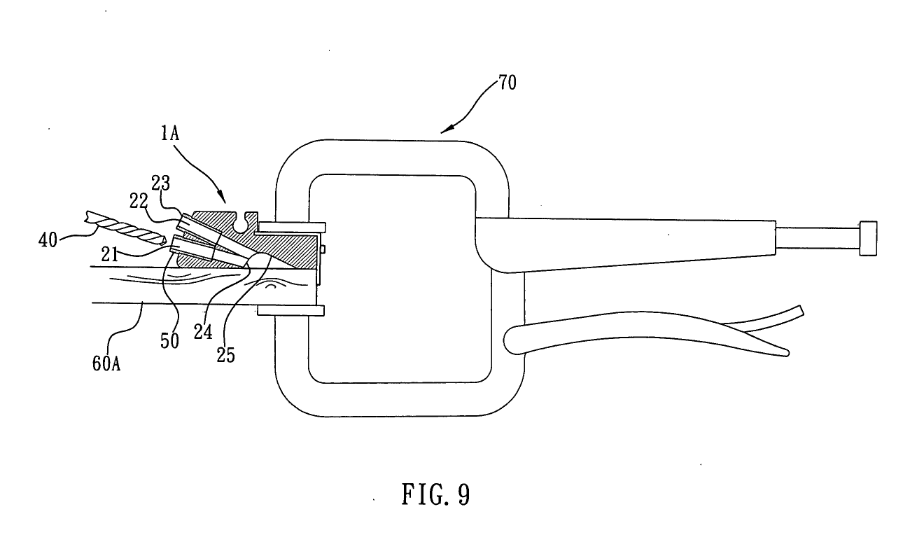

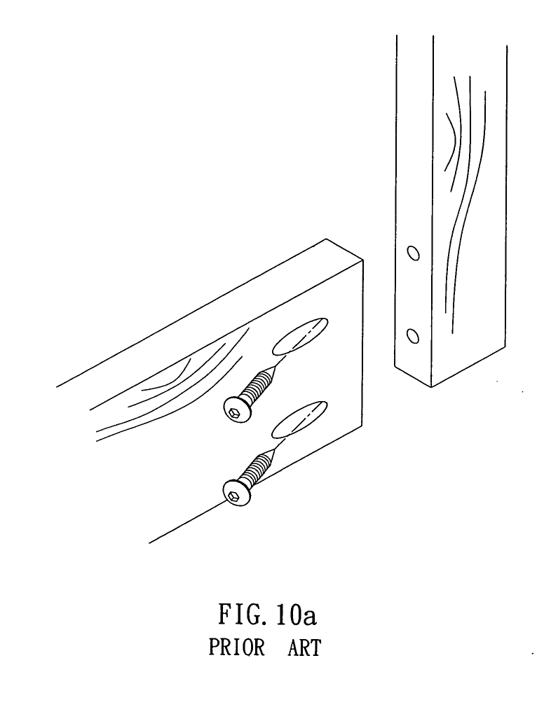

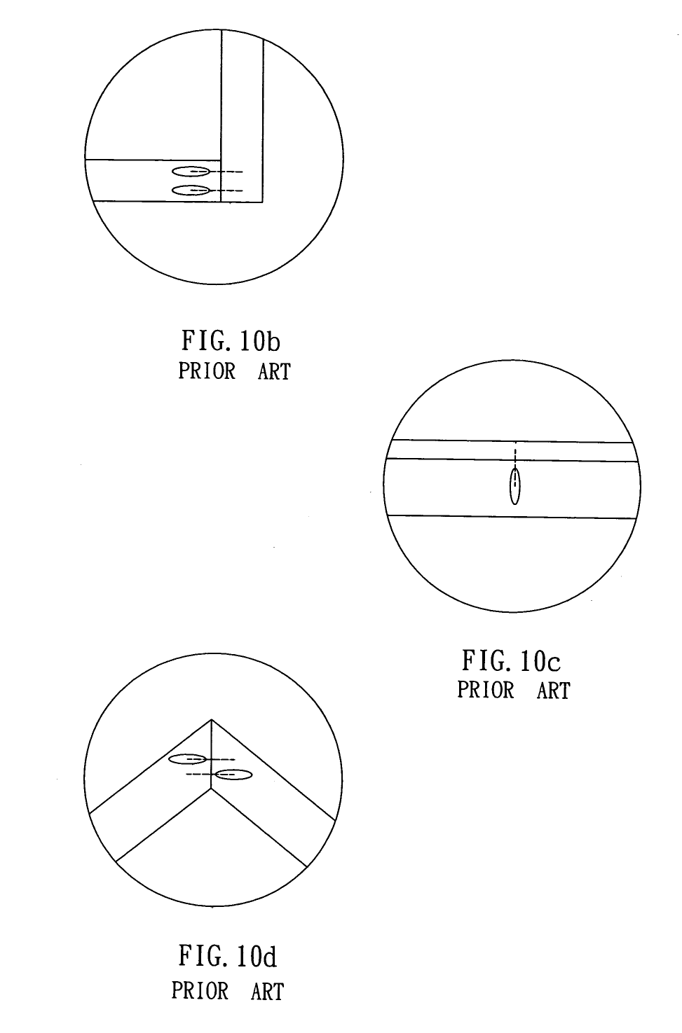

As FIGS. 6 and 7 illustrate another embodiment of the present invention, the drilling jig 1A comprises merely a frame 10A and a guide seat 20 thereon but without the aforesaid workpiece positioner 30; wherein the frame 10A can be a simple L-shaped frame that includes a sliding groove 12 on the bottom thereof and each guide seat 20 can be fastened to the frame 10A by means of a fastening stud 28. In the particular embodiment, one of the studs 28 is slidable along the sliding groove 12 so that the guide seats 20 can be spaced according to the desired positions of inclined holes to be made on the objective workpiece 60A. Thereby, as shown in FIGS. 8 and 9, an existing fixture 70 can be used to fix the frame 10A as well as the guide seat 20 with an objective workpiece 60A and the drilling operation can proceed as discussed above.

As the conventional drilling jig has merely a single inclined guide channel on the seat and cannot fit various thicknesses of workpieces, an alternative seat equipped with a guide channel in a different inclination is necessary to avoid drilling offset. Thus, such conventional drilling jig is handicapped by inconvenience of use and uneconomic cost of manufacture.

Thereagainst, the guide seat 20 of the present invention is of the novel design of being equipped with at least two inclined guide channels 21, 22 with diverse inclinations to provide at least two options for drilling inclination and satisfies users' diverse demands to accomplish the advancement of practicality.

The novel advantages presented by the present invention are described as follows:

1. Because the guide seat 20 has a concave chip groove 25 on the sidewall thereof around the outlet end 24 of the inclined guide channels 21, 22, it facilitates easy drilling chip removal.

2. Since each inclined guide channel 21, 22 of the guide seat 20 contains a rigid liner tube 50 inside, it enhances the structure and introduces soundness as well as durability for the guide channels.

What is claimed is:

1. An inclined-hole drilling jig primarily comprising a frame, at least one guide seat assembled thereon, and a workpiece positioner; wherein, the guide seats each have plural inclined guide channels to accommodate and orient a drill and the inlet ends of the channels appear at the top surface of the guide seat while the outlet ends thereof appear at one sidewall of the guide seat; and wherein each guide seat is equipped with at least one first inclined guide channel and one second inclined guide channel.

2. The inclined-hole drilling jig as claimed in claim 1, further comprising a concave chip groove provided on the sidewall of said guide seat around the outlet end of the inclined guide channel.

3. The inclined-hole drilling jig as claimed in claim 1, further comprising a rigid liner tube assembled inside the inclined guide channels of the guide seat.

4. The inclined-hole drilling jig as claimed in claim 1, wherein the workpiece positioner is a clamping seat.

5. The inclined-hole drilling jig as claimed in claim 1, wherein the guide seats assembled on the frame are adjustable to be relatively close or distant.

6. An inclined-hole drilling jig primarily comprising a frame, and at least one guide seat assembled thereon; wherein, the guide seats each have plural inclined guide channels to accommodate and orient a drill and the inlet ends of the channels appear at the top surface of the guide seat while the outlet ends thereof appear at one sidewall of the guide seat; and wherein each guide seat is equipped with at least one first inclined guide channel and one second inclined guide channel;

7. The inclined-hole drilling jig as claimed in claim 6, further comprising a concave chip groove provided on the sidewall of said guide seat around the outlet end of the inclined guide channel.

8. The inclined-hole drilling jig as claimed in claim 6, further comprising a rigid liner tube assembled inside the inclined guide channels of the guide seat.

9. The inclined-hole drilling jig as claimed in claim 6, wherein the frame is an L-shaped frame.

10. The inclined-hole drilling jig as claimed in claim 6, wherein the guide seats assembled on the frame are adjustable to be relatively close or distant.

11. The inclined-hole drilling jig as claimed in claim 6, wherein each said guide seat is fastened to the frame by means of a fastening stud.

12. The inclined-hole drilling jig as claimed in claim 9, wherein the frame includes a sliding groove on the bottom thereof.
